(19) United States
(12) Patent Application Publication
(10) Pub. No.: US 2024/0166807 A1
(43) Pub. Date: May 23, 2024

(54) POLYETHYLENE TEREPHTHALATE (PET) COPOLYESTER AND MANUFACTURING METHOD THEREOF

(71) Applicant: NAN YA PLASTICS CORPORATION, TAIPEL (TW)

(72) Inventors: Te-Chao Liao, TAIPEI (TW); Han-Ching Hsu, TAIPEI (TW); Chen-Wei Chang, TAIPEI (TW)

(73) Assignee: NAN YA PLASTICS CORPORATION, TAIPEI (TW)

(21) Appl. No.: 18/091,412

(22) Filed: Dec. 30, 2022

(30) Foreign Application Priority Data
Nov. 21, 2022 (TW) 111144453

(51) Int. Cl. C08G 63/80; C08G 63/06

(52) U.S. Cl. CPC C08G 63/80; C08G 63/06

(57) ABSTRACT

A polyethylene terephthalate (PET) copolyester and a manufacturing method thereof are provided. The manufacturing method includes the following steps. A dispersion slurry including a talcum powder is formulated, wherein the talcum powder has an average particle size of 1 μm to 50 μm and an average specific surface area of 7 m²/g to 20 m²/g. Next, a terephthalic acid and an ethylene glycol are mixed, and the dispersion slurry and a crystallization accelerator are introduced, so as to carry out a transesterification reaction and therefore form a bis-2-hydroxylethyl terephthalate (BHET). Afterwards, a prepolymerization reaction and a polycondensation reaction are carried out to form a polyethylene terephthalate (PET) copolyester.

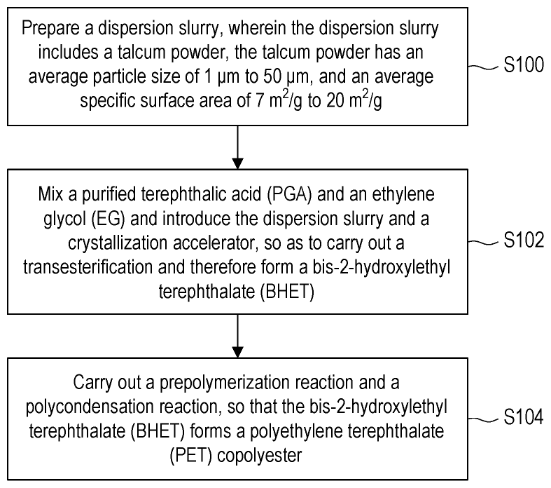

### CROSS-REFERENCE TO RELATED APPLICATION

This application claims the priority benefit of Taiwan application serial no. 111144453, filed on Nov. 21, 2022. The entirety of the above-mentioned patent application is hereby incorporated by reference herein and made a part of this specification.

### BACKGROUND

### Technical Field

The present disclosure relates to a polyethylene terephthalate (PET) copolyester, and particularly to a rapidly crystallizable polyethylene terephthalate (PET) copolyester and a manufacturing method thereof.

### Description of Related Art

Generally speaking, the crystallization rate of a polyethylene terephthalate (PET) resin is slower than that of a polybutylene terephthalate (PBT) resin, so that a higher molding temperature and a longer cooling time are required when the PET resin is subjected to an injection processing. Accordingly, the application of the PET resin in engineering plastics is limited.

Therefore, it becomes an important topic in the industry to develop a PET resin with an increased crystallization rate, thereby shortening the injection molding time and expanding the product application.

### SUMMARY

The disclosure provides a polyethylene terephthalate (PET) copolyester and a manufacturing method thereof, in which the PET polymer has the advantages of rapid crystallization rate and high crystallinity, and therefore effectively shortens the injection molding time.

The disclosure provides a manufacturing method of a polyethylene terephthalate (PET) copolyester that includes the following steps. A dispersion slurry is prepared, wherein the dispersion slurry includes a talcum powder, the talcum powder has an average particle size of 1 μm to 50 μm and an average specific surface area of 7 m²/g to 20 m²/g. Next, a terephthalic acid and an ethylene glycol are mixed, and the dispersion slurry and a crystallization accelerator are introduced, so as to carry out a transesterification reaction and therefore form a bis-2-hydroxylethyl terephthalate (BHET). Afterwards, a polyethylene terephthalate (PET) copolyester is formed by subjecting the bis-2-hydroxylethyl terephthalate (BHET) to a prepolymerization reaction and a polycondensation reaction.

In an embodiment of the present disclosure, a shape of the talcum powder has an irregular or round granular structure.

In an embodiment of the present disclosure, based on a total weight of the dispersion slurry, a content of the talcum powder ranges from 0.5 wt % to 1.0 wt %.

In an embodiment of the present disclosure, the dispersion slurry further includes a dispersant and an ethylene glycol, and based on a total weight of the dispersion slurry, a content of the dispersant ranges from 0.01 wt % to 1 wt %.

In an embodiment of the present disclosure, based on a total weight of the bis-2-hydroxylethyl terephthalate (BHET), an added amount of the dispersion slurry ranges from 98.0 wt % to 99.0 wt %.

In an embodiment of the present disclosure, based on a total weight of the bis-2-hydroxylethyl terephthalate (BHET), an added amount of the talcum powder ranges from 0.5 wt % to 1.0 wt %.

In an embodiment of the present disclosure, the crystallization accelerator is selected from at least one of a polyethylene glycol, a polyether diol and a polyester diol.

In an embodiment of the present disclosure, based on a total weight of the bis-2-hydroxylethyl terephthalate (BHET), an added amount of the crystallization accelerator ranges from 1 wt % to 5 wt %.

In an embodiment of the present disclosure, during the transesterification reaction, an equivalent ratio of the terephthalic acid to the ethylene glycol ranges from 1:1.3 to 1:1.5, a reaction temperature ranges from 250° C. to 260° C., and a reaction time ranges from 2 hours to 3 hours.

In an embodiment of the present disclosure, during the prepolymerization reaction, reactants include the bis-2-hydroxylethyl terephthalate and a polyethylene glycol (PEG), wherein based on a total weight of the bis-2-hydroxylethyl terephthalate, a content of the polyethylene glycol ranges from 4 wt % to 8 wt %, a reaction temperature ranges from 250° C. to 260° C., a vacuum degree is 40 mmHg, and a reaction time ranges from 1 hour to 2 hours.

In an embodiment of the present disclosure, the polycondensation reaction is carried out after the prepolymerization reaction, and during the polycondensation reaction, a reaction temperature ranges from 270° C. to 285° C., a vacuum degree ranges from 1 mmHg to 2 mmHg, and a reaction time ranges from 2 hours to 4 hours.

The disclosure provides a polyethylene terephthalate (PET) copolyester made by the manufacturing method described above.

Based on the above, in the present disclosure, a tale-containing dispersion slurry and a crystallization accelerator are introduced into the reaction process of manufacturing a PET copolyester. The talcum powder with a small particle size and a high specific surface area is beneficial to induce the PET nucleation and therefore improve the crystallization rate. In addition, the crystallization accelerator can delay the solidification of the PET segments, which is beneficial to crystallize PET and therefore improve the crystallization ability. The PET copolyester manufactured by the above method can effectively reduce the processing time of injection molding and expand its applicability due to its rapid crystallization and high crystallinity.

### BRIEF DESCRIPTION OF THE DRAWINGS

The FIGURE is a schematic flow chart of a manufacturing method of a polyethylene terephthalate (PET) copolyester according to an embodiment of the present disclosure.

### DESCRIPTION OF THE EMBODIMENTS

Embodiments of the disclosure will be described in details below. However, these embodiments are illustrative, and the disclosure is not limited thereto.

Herein, a range indicated by “one value to another value” is a general representation which avoids enumerating all values in the range in the specification. Therefore, the description of a specific numerical range covers any numerical value within the numerical range and the smaller numerical range bounded by any numerical value within the numerical range, as if the arbitrary numerical value and the smaller numerical range are written in the specification.

The FIGURE is a schematic flow chart of a manufacturing method of a polyethylene terephthalate (PET) copolyester according to an embodiment of the present disclosure.

Referring to the FIGURE, step S100 is performed, in which a dispersion slurry is prepared, and the dispersion slurry includes a talcum powder (or called “tale” in some examples). In this embodiment, the dispersion slurry further includes a dispersant and an ethylene glycol (EG), but the disclosure is not limited thereto. Herein, the preparation method of the dispersion slurry includes, for example but not limited to, mixing the talcum powder, the dispersant and the ethylene glycol, and stirring the mixture under ultrasonic vibration at room temperature for 1 hour.

Specifically, the talcum powder may be a superfine talcum powder, and can serve as a nucleating agent. In some embodiments, the shape of talcum powder may have an irregular or round granular structure, the average particle size may range from 1 μm to 50 μm, and the average specific surface area may range from 7 m²/g to 20 m²/g. In some preferred embodiments, the average particle size of the talcum powder may range from 1 μm to 10 μm, and the average specific surface area may range from 14 m²/g to 20 m²/g. The specific surface area of the talcum powder is high due to its small particle size, which can induce the accelerated nucleation of PET, and therefore increase the crystallization rate of PET.

In some embodiments, based on the total weight of the dispersion slurry, the content of the talcum powder may range from 0.5 wt % to 1.0 wt %. In some preferred embodiments, the content of the talcum powder may range from 0.5 wt % to 0.9 wt %. In some more preferred embodiments, the content of the talcum powder may range from 0.6 wt % to 0.9 wt %. When the content of the talcum powder in the dispersion slurry is greater than 1.0 wt %, the tale accumulation is likely to occur due to excessive talcum powder. When the content of the talcum powder in the dispersion slurry is less than 0.5 wt %, it may be difficult to crystallize PET because the content of the talcum powder is too low. When the content of talcum powder is between 0.6 wt % and 0.8 wt %, the crystallization rate of PET can be greatly improved.

The dispersant may include a coupling agent containing a hydroxyl functional group, such as hexyltrimethoxysilane; a chelating titanate coupling agent such as bis(octylpyrophosphate)glycolic acid titanate, etc., for dispersing components in the dispersion solution (i.e., dispersion slurry). In some embodiments, based on the total weight of the dispersion slurry, the content of the dispersant may range from 0.01 wt % to 1 wt %. In some preferred embodiments, the content of the dispersant may range from 0.10% to 0.5 wt %. In some more preferred embodiments, the content of the dispersant may range from 0.2% to 0.4 wt %. In some even more preferred embodiments, the content of the dispersant may range from 0.2 wt % to 0.3 wt %. When the content of the dispersant in the dispersion slurry is greater than 1 wt %, the dispersion uniformity becomes poor, and the reactivity of the polycondensation reaction of a copolyester is deteriorated. When the content of the dispersant in the dispersion slurry is less than 0.01 wt %, the components in the solution may not be effectively dispersed due to the low content of the dispersant, resulting in accumulation phenomenon. When the content of the dispersion is between 0.2 wt % and 0.3 wt %, a good dispersion effect can be achieved.

Referring to the FIGURE again, step S102 is performed, in which a terephthalic acid (or called “purified terephthalic acid (PTA)” in some examples) and an ethylene glycol (EG) are mixed, and the dispersion slurry and a crystallization accelerator are introduced, so as to carry out a transesterification reaction to form a bis-2-hydroxylethyl terephthalate (BHET). In an embodiment of the present disclosure, the main reactants for the transesterification reaction (that is, the raw materials for the synthesis of bis-2-hydroxylethyl terephthalate) include a terephthalic acid and an ethylene glycol, wherein the equivalent ratio of the terephthalic acid to the ethylene glycol may range from about 1:1.3 to 1:1.5, the reaction temperature may range from about 250° C. to 260° C., and the reaction time may range from about 2 hours to 3 hours. When the reaction conditions are set as above, there is an esterification rate of about 82%, but the disclosure not limited thereto.

Specifically, the addition of a dispersion slurry, a crystallization accelerator, an antioxidant and/or an additional nucleating agent may be further included, so as to help the nucleation and crystallization stages when forming PET in step S102 and step S104. Based on the total weight of the bis-2-hydroxylethyl terephthalate (BHET), the added amount of the dispersion slurry may range from 99.0 wt % to 98.0 wt %, that is, the added amount of the talcum powder may range from about 0.05 wt % to 1 wt %, preferably from about 0.1 wt % to 1 wt %, more preferably from about 0.5 wt % to 1 wt %. When the added amount of the talcum powder is less than 0.05 wt %, the talcum powder has no effect because the added amount is too small. When the added amount of the talcum powder is greater than 1 wt %, the nucleation rate is not greatly improved, and excessive talcum powder affects the reaction rate. When the added amount of talcum powder (or dispersion slurry) falls within the above-mentioned range, the crystallization time of PET can be effectively shortened to increase the crystallization rate.

In this embodiment, the crystallization accelerator may be selected from at least one of a polyethylene glycol, a polyether diol, and a polyester diol, but the disclosure is not limited thereto. In some embodiments, based on the total weight of the bis-2-hydroxylethyl terephthalate (BHET), the added amount of the crystallization accelerator may range from 1 wt % to 5 wt %; preferably from 2 wt % to 3 wt %. When the added amount of the crystallization accelerator is less than 1 wt %, the crystallization accelerator has no effect because the added amount is too small. When the added amount of the crystallization accelerator is greater than 5 wt %, the incompatibility issue may occur due to excessive content, resulting in a decrease in physical properties of the final product. When the added amount of the crystallization accelerator falls within the above-mentioned range, the solidification of the PET chain can be delayed to facilitate crystallization, so the crystallization ability of the PET resin can be improved and the degree of crystallinity can be increased.

In this embodiment, the antioxidant may include, for example but not limited to, hindered phenol (trade name I1010 from Ciba corporation), trimethyl-phenyl phosphite, etc., for reducing oxidation during the reaction. The antioxidant abilities of different antioxidants are different, so the added amount may be adjusted as appropriate. For example, in some embodiments, when the antioxidant is hindered phenol I1010, based on the total weight of the bis-2-hydroxylethyl terephthalate (BHET), the added amount of the hindered phenol I1010 may range from 0.1 wt % to 0.3 wt %. In some other embodiments, when the antioxidant is trimethyl-phenyl phosphite, based on the total weight of the bis-2-hydroxylethyl terephthalate (BHET), the added amount of trimethyl-phenyl phosphite may range from 0.01 wt % to 0.05 wt %.

In this embodiment, the additional nucleating agent may include, for example but not limited to, a sodium organometallic compound. Specifically, since the talcum powder in the dispersion slurry serves as a nucleating agent, the addition of an additional nucleating agent is used to supplement the insufficient part (if any) of the nucleating agent. That is to say, the amount of the additional nucleating agent may correspond to that of the talcum powder.

Referring to the FIGURE again, step S104 is performed, in which a prepolymerization reaction and a polycondensation reaction are carried out, so that the bis-2-hydroxylethyl terephthalate (BHET) forms a polyethylene terephthalate (PET) copolyester.

Specifically, during the prepolymerization reaction, the reactants may include the bis-2-hydroxylethyl terephthalate (BHET) and a polyethylene glycol (PEG). Based on the total weight of the bis-2-hydroxylethyl terephthalate (BHET), the content of polyethylene glycol (PEG) may range from 2 wt % to 10 wt % (preferably from about 4 wt % to 8 wt %), the reaction temperature may range from 250° C. to 260° C., the vacuum degree is slowly reduced to 40 Torr (i.e., mmHg), and the reaction time may range from 1 hour to 2 hours.

In this embodiment, a catalyst, a heat stabilizer and an oligomer are further added before performing the prepolymerization reaction. The catalyst may include, for example but not limited to, stannous octoate, for catalyzing the reaction. The heat stabilizer may include, for example but not limited to, triphenyl phosphite, for stabilizing the hue of the product and reducing the by-product formation. The oligomer may include, for example but not limited to, an aliphatic diacid ester, for modifying PET to adjust its structure to have asymmetry. In some embodiments, based on the total weight of the bis-2-hydroxylethyl terephthalate (BHET), the oligomer can be added in an amount of about 1 wt % to 10 wt %, preferably in an amount of about 3 wt % to 8 wt %, and more preferably in an amount of about 3 wt % to 6 wt %.

The polycondensation reaction is carried out after the prepolymerization reaction. In this embodiment, during the polycondensation reaction, the reaction temperature may range from 270° C. to 285° C., the vacuum degree may range from 1 Torr to 2 Torr, and the reaction time may range from 2 hours to 4 hours. More specifically, the reaction is ended when the stirring power is increased from 80 watts (w) to 120-130 watts. The manufacture of a PET copolyester is thus completed.

Generally speaking, in the conventional PET injection processing, there are following problems: (1) terephthalic acid and ethylene glycol are used as raw materials, but the short chain of ethylene glycol is not flexible and therefore the crystallization ability of PET is hindered; and (2) PET has a rigid structure with a high melting point, so a higher temperature is required during the injection molding process. Therefore, the application field of the conventional PET is limited. In the embodiment of the present disclosure, a tale-containing dispersion slurry is added during polymerization, so the small particle size and the high specific surface area of the talcum powder are beneficial to induce the PET nucleation and therefore improve the crystallization rate. In addition, a crystallization accelerator is further added during polymerization, so the solidification of PET can be delayed to facilitate crystallization, thereby improving the crystallization ability. The PET copolyester manufactured by the above-mentioned optimized process has the advantages of rapid crystallization, shortened half-crystallization time, high crystallinity, and shortened injection molding processing time.

Hereinafter, the PET copolyesters of the present disclosure and manufacturing methods thereof will be described in detail by means of experimental examples. However, the following experimental examples are not intended to limit the present disclosure.

### Experimental Examples

The PET copolyesters and manufacturing methods proposed by the present disclosure have rapid crystallization ability and therefore shorten the half-crystallization time. Examples are provided below for illustration.

<PET Copolyesters of Comparative Example and Examples 1-6>

The compositions, contents and physical property analysis results of the conventional PET copolyester of Comparative Example and the modified PET copolyesters of Examples 1 to 6 are described in Table 1 below. In addition, the preparation methods of the modified PET copolyesters may refer to those described above.

<Physical Property Analysis>

“Thermal property analysis” indicates using a differential scanning calorimetry (DSC) to test various thermal coefficients. Specifically, the sample is heated to 290° C. at 20° C./min, maintained for 1 minute to eliminate thermal history, and then cooled to 20° C. at 20° C./min, followed by heating up to 290° C. at 20° C./min, so as to measure a glass transition temperature (Tg), a melting point (Tm), a crystallization temperature (Tc), a crystallization enthalpy (ΔHc), a supercooling degree and a half-crystallization time.

“Viscosity (IV) analysis” indicates dissolving the sample in phenol/trichloroethylene (TCE) (in a constant temperature bath at 30° C.), with a stirring motor (115V.50/60CY, 1.2 A, 1550 rpm) to provide slight agitation, so as to measure the viscosity with a viscometer.

TABLE 1

| | | | Comparative | | | | | | |
|---|---|---|---|---|---|---|---|---|---|
| | | | Example | Example 1 | Example 2 | Example 3 | Example 4 | Example 5 | Example 6 |
| component | bis-2-hydroxylethyl terephthalate | | 500 | 500 | 500 | 500 | 500 | 500 | 500 |
| (g) | polyethylene glycol | | 10 | 20 | 20 | 20 | 20 | 40 | 20 |
| | aliphatic diacid ester | | 5 | 15 | 15 | 15 | 15 | 15 | 30 |
| | superfine talcum powder | | | 2.5 | | | 5.0 | 2.5 | 2.5 |
| | modified talcum powder | | | | 2.5 | | | | |
| | high aspect ratio talcum powder | | | | | 2.5 | | | |
| physical | heating | glass transition temperature (° C.) | 78 | 61 | 61 | 62 | 63 | 66 | 58 |
| properties | | melting point (° C.) | 258 | 232 | 231 | 231 | 235 | 236 | 228 |
| | cooling | crystallization temperature (° C.) | 182 | 185 | 170 | 189 | 180 | 188 | 174 |
| | | crystallization enthalpy (J/g) | 14 | 44 | 42 | 38 | 45 | 38 | 30 |

| | | | | | | | |
|---|---|---|---|---|---|---|---|
| supercooling degree (° C.) | 76 | 47 | 61 | 42 | 43 | 48 | 54 |
| half-crystallization time (min) | 0.97 | 0.36 | 0.82 | 0.45 | 0.34 | 0.45 | 0.62 |
| viscosity (dl/g) | 0.76 | 0.71 | 0.62 | 0.64 | 0.61 | 0.66 | 0.62 |

As shown in Table 1, as compared with the conventional PET copolyester of Comparative Example, a crystallization accelerator (e.g., polyethylene glycol) and a nucleating agent (e.g., superfine talcum powder, modified talcum powder or high aspect ratio talcum powder) are further added to each of the modified PET copolyesters of Examples 1-6. Specifically, the PET copolyesters of Examples 1-3 are different in types of the nucleating agents, e.g., 2.5 g of superfine talcum powder (Example 1), 2.5 g of modified talcum powder (Example 2) and 2.5 g of high aspect ratio talcum powder (Example 3). The difference between Example 1 and Example 4 lies in that the added amounts of the nucleating agent are different, e.g., 2.5 g of superfine talcum powder (Example 1) and 5.0 g of superfine talcum powder (Example 4). The difference between Example 1 and Example 5 lies in that the added amounts of polyethylene glycol are different, e.g., 20 g of polyethylene glycol (Example 1) and 40 g of polyethylene glycol (Example 5). The difference between Example 1 and Example 6 lies in that the added amounts of oligomer (e.g., aliphatic diacid ester) are different, e.g., 15 g of oligomer (Example 1) and 30 g of oligomer (Example 6).

According to the results of physical property analysis, as compared with the conventional PET copolyester of Comparative Example, the modified PET copolyesters of Examples 1-6 achieve better performance. Specifically, when a superfine talcum powder serves as a nucleating agent, based on the total weight of bis-2-hydroxylethyl terephthalate, the added amount of the superfine talcum powder ranges from 0.5 wt % to 1 wt % (Example 1, Example 4), the crystallization enthalpy reaches 44 J/g to 45 J/g, and the half-crystallization time is shortened to 0.34 minutes to 0.36 minutes. The results show that the superfine talcum powder can effectively shorten the half-crystallization time and accelerate the crystallization rate.

In addition, the modified talcum powder has a slightly poor nucleating effect due to its wide particle size distribution and uneven particle size. The high aspect ratio talcum powder has the lowest degree of supercooling, because the layered structure accelerates the induction of nucleation and crystallization, and has slightly lower crystallization enthalpy due to the larger particle size. In addition, the present disclosure can effectively reduce the melting point of the copolyester by increasing the added amount of the oligomer from 1 wt % (Comparative Example) to 3-6 wt % (Examples 1-6), so a molding processing can be performed at a lower processing temperature, and the flow ability of PET processing can be improved.

In summary, in the present disclosure, a tale-containing dispersion slurry and a crystallization accelerator are introduced into the reaction process of manufacturing a PET copolyester. The talcum powder with a small particle size and a high specific surface area is beneficial to induce the PET nucleation and therefore improve the crystallization rate. In addition, the crystallization accelerator can delay the solidification of the PET segments, which is beneficial to crystallize PET and therefore improve the crystallization ability. The PET copolyester manufactured by the above method can effectively reduce the processing time of injection molding and expand its applicability due to its rapid crystallization and high crystallinity.

Although the present disclosure has been disclosed above with the embodiments, it is not intended to limit the present disclosure. Anyone with ordinary knowledge in the technical field may make some changes and modifications without departing from the spirit and scope of the present disclosure. The scope of protection of the present disclosure should be defined by the scope of the appended patent application.

What is claimed is:

1. A manufacturing method of a polyethylene terephthalate copolyester, comprising:
preparing a dispersion slurry, wherein the dispersion slurry comprises a talcum powder;
mixing a terephthalic acid and an ethylene glycol, and introducing the dispersion slurry and a crystallization accelerator, so as to carry out a transesterification and therefore form a bis-2-hydroxylethyl terephthalate; and
carrying out a prepolymerization reaction and a polycondensation reaction, so that the bis-2-hydroxylethyl terephthalate forms a polyethylene terephthalate copolyester,
wherein the talcum powder has an average particle size of 1 μm to 50 μm, and an average specific surface area of 7 m²/g to 20 m²/g.

2. The manufacturing method of claim 1, wherein based on a total weight of the dispersion slurry, a content of the talcum powder ranges from 0.5 wt % to 1.0 wt %.

3. The manufacturing method of claim 1, wherein the dispersion slurry further comprises a dispersant and an ethylene glycol, and based on a total weight of the dispersion slurry, a content of the dispersant ranges from 0.01 wt % to 1 wt %.

4. The manufacturing method of claim 1, wherein based on a total weight of the bis-2-hydroxylethyl terephthalate, an added amount of the dispersion slurry ranges from 98.0 wt % to 99.0 wt %.

5. The manufacturing method of claim 1, wherein the crystallization accelerator is selected from at least one of a polyethylene glycol, a polyether diol and a polyester diol.

6. The manufacturing method of claim 1, wherein based on a total weight of the bis-2-hydroxylethyl terephthalate, an added amount of the crystallization accelerator ranges from 1 wt % to 5 wt %.

7. The manufacturing method of claim 1, wherein during the transesterification reaction, an equivalent ratio of the terephthalic acid to the ethylene glycol ranges from 1:1.3 to 1:1.5, a reaction temperature ranges from 250° C. to 260° C., and a reaction time ranges from 2 hours to 3 hours.

8. The manufacturing method of claim 1, wherein during the prepolymerization reaction, reactants comprise the bis-2-hydroxylethyl terephthalate and a polyethylene glycol, wherein based on a total weight of the bis-2-hydroxylethyl terephthalate, a content of the polyethylene glycol ranges from 4 wt % to 8 wt %, a reaction temperature ranges from 250° C. to 260° C., a vacuum degree is 40 mmHg, and a reaction time ranges from 1 hour to 2 hours.

9. The manufacturing method of claim 1, wherein the polycondensation reaction is carried out after the prepolymerization reaction, and during the polycondensation reaction, a reaction temperature ranges from 270° C. to 285° C., a vacuum degree ranges from 1 mmHg to 2 mmHg, and a reaction time ranges from 2 hours to 4 hours.

10. A polyethylene terephthalate copolyester, made by the manufacturing method of claim 1.
